(19) United States
(12) Patent Application Publication
(10) Pub. No.: US 2025/0014206 A1
(43) Pub. Date: Jan. 9, 2025

(54) OBJECT DETECTION IN VIDEO IMAGE FRAMES

(71) Applicant: Curtis Ray Robinson, JR., Rochester, NY (US)

(72) Inventor: Curtis Ray Robinson, JR., Rochester, NY (US)

(21) Appl. No.: 18/709,766

(22) PCT Filed: Nov. 16, 2022
(86) PCT No.: PCT/US22/50072

§ 371 Date: May 13, 2024

Related U.S. Application Data
(60) Provisional application No. 63/281,051, filed on Nov. 18, 2021.

(51) Int. Cl. G06T 7/70; G06T 7/50; G06V 10/75; G06V 20/70; G06V 30/10

(52) U.S. Cl. CPC G06T 7/70; G06T 7/50; G06V 10/751; G06V 20/70; G06V 30/10; G06V 2201/07

(57) ABSTRACT

Performing object detection in a video feed can include using a main object detector and a backup object detector. The backup object detector compares background or border patterns in select locations between different image frames of the video feed and labels the image frames containing the object when the main object detector fails to identify the object. In some embodiments, the image frames labeled by the backup object detector are used to further train and improve the main object detector.

### CROSS-REFERENCE TO RELATED APPLICATIONS

This application claims the benefit of priority of U.S. Provisional Application No. 63/281,051, filed on Nov. 18, 2021, entitled “OBJECT DETECTION IN VIDEO IMAGE FRAMES,” which is hereby incorporated by reference in its entirety and should be considered a part of this specification.

### FIELD

This application relates generally to the field of object detection, and more specifically to object detection in video feeds.

### SUMMARY

The appended claims may serve as a summary of this application.

### BRIEF DESCRIPTION OF THE DRAWINGS

FIG. 1 illustrates an example operation of an object detector.

FIG. 2 is an example illustrating the operations of a backup object detector.

FIG. 3 illustrates a situation when the main object detector has failed to recognize an object, while the backup object detector correctly identifies the object.

FIG. 4 illustrates a situation where the same object appears in two video image frames.

FIG. 5 illustrates a method of object detection and post processing according to an embodiment.

FIG. 6 illustrates an environment in which some embodiments may operate.

### DETAILED DESCRIPTION OF THE DRAWINGS

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Extracting data from a video feed can have a variety of applications in numerous fields. Object detection and processing can play a major role in extracting data from a video feed. Typically, a video feed is made up of a stream of images played at a frames per second rate. Image frames can be processed by a variety of object detectors to extract useful data. With the recent advancements in the field of artificial intelligence (AI), object detectors can be built and customized, based on AI models. Such AI models excel in identifying objects in video image frames. However, object detectors, including AI object detectors are not perfect. In some instances, they miss an object they are configured to identify. Furthermore, object detection and processing in video image frames can be computationally burdensome tasks, especially if combined with other data processing techniques, such as optical character recognition (OCR). The described embodiments disclose systems and methods for efficient object detection, including systems and methods that can be used to both provide a backup or secondary object detection for a main object detector, as well as to train and improve the main object detector, by detecting more image frames of a video feed that include a selected object.

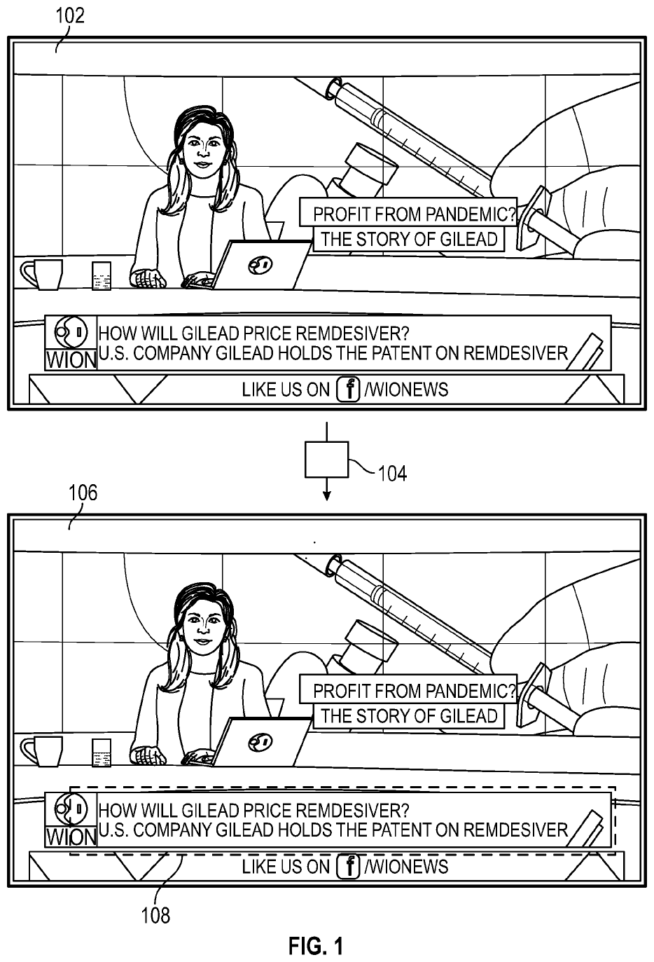

FIG. 1 illustrates an example operation of a main object detector 104. An image frame 102 can be an example image frame from a video feed. As an example, the main object detector 104 can be an AI model or a collection of AI models, trained and configured to detect text and/or textboxes within an image frame. The image frame 106 is the same image frame as the image frame 102, but with a rectangle textbox object 108, surrounding the text detected by the main object detector 104. Stated otherwise, FIG. 1 illustrates an instance where the main object detector 104 has successfully detected a text object 108.

In scenarios where the main object detector 104 is successful in detecting an object 108 in the image frame, the image frame is not further processed by a backup object detector. On the other hand, if the main object detector 104 indicates an image frame does not contain the object 108, the image frame can further be processed through a backup object detector. If the backup object detector identifies the object 108 in the image frame, the image frame can be labeled as an image frame containing the object 108 and can be later used for further training and improving the main object detector 104.

The backup object detector can detect the presence of the object 108, based on analyzing a pixel value pattern in a location known or predicted to include the object 108. As an example, the image frame 102 is from a video feed of a news broadcast. The object 108 is a text object that may generally occur with some frequency at the bottom of the screen in the bottom of the image frame 102. The text might change from image frame to image frame, but the location of the text, color of the text and background of the text may remain substantially similar from image frame to image frame. A backup object detector can search for the object 108 in a known or predicted location by analyzing one or more selected regions of the object 108 and by comparing pixel values and patterns in those regions with a known or predicted object 108.

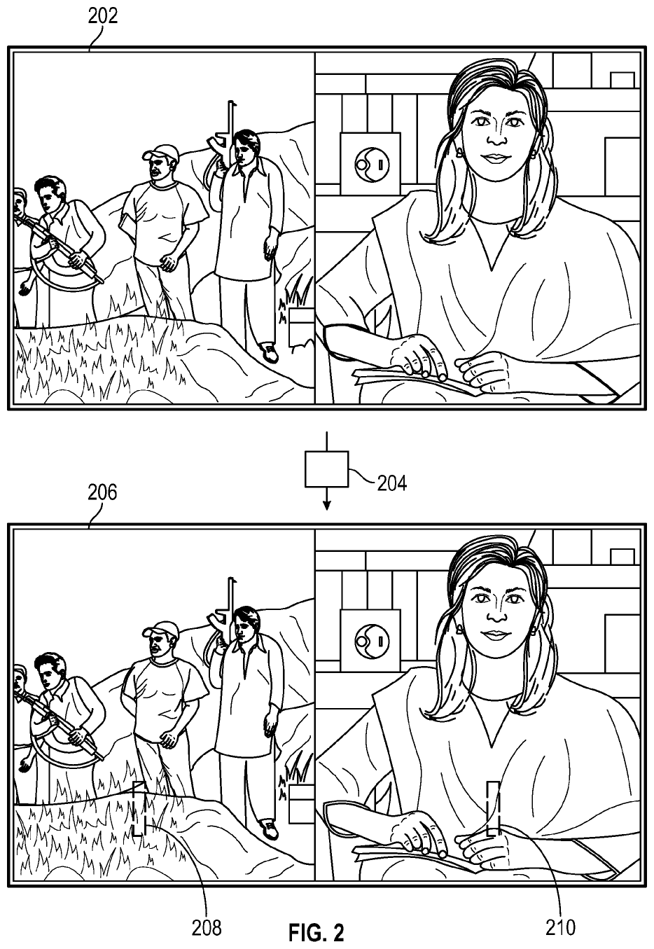

FIG. 2 is an example illustrating the operations of a backup object detector 204. An image frame 202 from a video feed (e.g., news broadcast) is first processed by the main object detector 104 and determined to not have included the object 108 (a textbox in this example). The backup object detector 204 is configured to include the location of an expected or predicted object 108, as well as a pixel pattern of the object 108 in one or more search regions 208, 210. Referring to both FIGS. 1 and 2, the search regions 208, 210 approximately correspond to two slivers of the background region in the object 108, where mostly a known or predicted and consistent pixel value pattern is expected (e.g., black border and black background or white border and white background and/or other colors or patterns). The backup object detector 204 searches for a known or predicted pixel value pattern in the search regions 208, 210. In the example shown, the Image frames 202, 206, in the search regions 208, 210 lack the same pixel pattern as the image frame 102, 104; consequently, the backup object detector 204, similar to the main object detector 104, also indicates a lack of the object 108 in the image frame 206.

The search regions 208, 210 can be selected by a variety of parameters. They can be chosen based on a geometric shape that approximates the expected location of the object 108. They can be chosen based on an expected pixel pattern in the object 108. The search regions 208, 210 can also be chosen based on an expected or predicted region of an image where the object 108 might appear. For example, in the case of a textbox in a news broadcast, as the object 108, a rectangle is expected to surround the text, and the object 108 is expected to appear at the bottom of an image. Such characteristics can inform the selection of the search regions 208, 210.

Furthermore, the number of search regions 208, 210 and their locations can depend on the geometric shape, and the pixel pattern in the geometric shape expecting to surround the object 108 or expected or predicted to be in the background of the object 108. Therefore, the search regions 208, 210 can be more than two or fewer than two regions. The search regions 208, 210 can be chosen within the geometric shape and where minimum color variation in pixel values are expected. This is to avoid or reduce the likelihood of a situation, where a background in a video image frame accidentally matches the pixel pattern in the object 108, leading to false positives. In other words, the backup object detector 204 can search the search regions 208, 210 in successive image frames detecting an expected or predicted consistent pixel pattern that can be an indication of existence of an object of interest in the successive image frames. The regions 208, 210, where the backup object detector 204 scans the successive image frames can be selected in areas of the successive image frames that are expected or predicted to have consistent pixel patterns if the object of interest were to appear in those successive image frames. For example, if the object of interest is the textbox 108 at the bottom of the screen, the search regions 208, 210 can be selected to be in an area of the image where the textbox is expected to appear (e.g., the bottom), and where those regions in the textbox are expected to have the least amount of variation amongst successive image frames. In the case of textboxes, such regions typically are near the borders or areas between the text in the textbox and the borders of the textbox.

In some embodiments, the geometric shape is chosen to include a margin or border region, and the search regions 208, 210 are chosen to be within this margin and/or border, in order to identify a consistent pixel pattern from one frame to another. In the textbox as object 108 example, the text in each textbox might change from frame to frame, while the background and border regions remain the same (e.g., black or blue). In these instances, if the search regions 208, 210 are chosen to overlap with text, the backup object detector 204 using those regions, may mistake a variation in text to be indicative of a different object in the location of the object 108 and miss a text object. In other words, the search regions 208, 210 are chosen to correspond to regions of the object 108 that are expected or predicted to remain consistent from one video image frame to another in terms of pixel patterns, locations, and other characteristics.

The expected location of the object 108 can depend on the characteristics of the object 108 and can be extracted from a known image frame. The backup object detector 204 can be configured with coordinates of a geometric shape approximating the boundaries of the expected object 108 with some margins as described above. In other embodiments, the shape approximating the object 108 does not have to be a geometric shape. For example, if the expected object 108 is a watermark of a logo, a non-geometric shape surrounding the object with some margins may be used to configure the backup object detector 204.

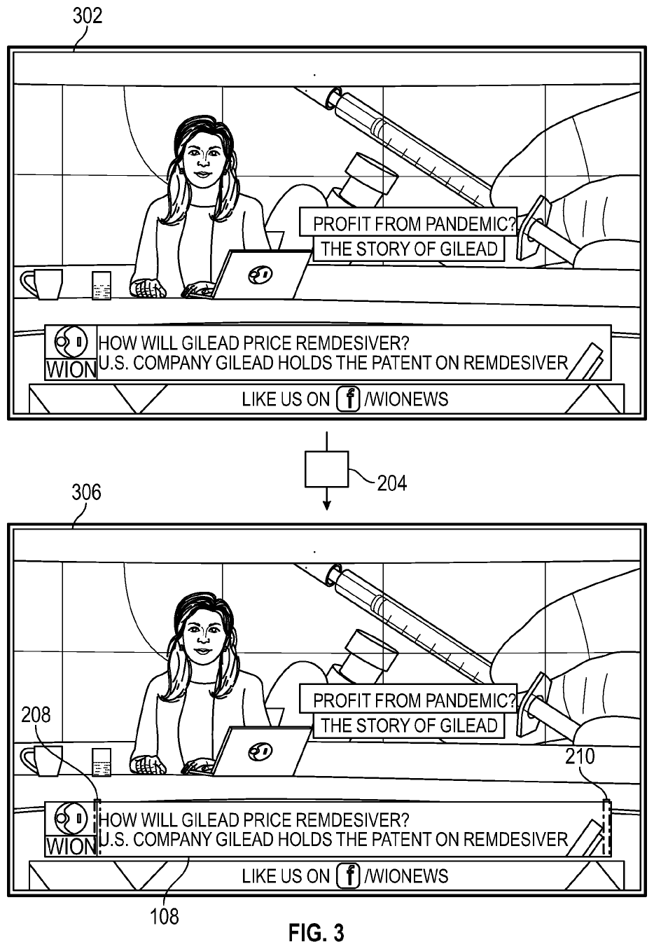

FIG. 3 illustrates a situation where the main object detector 104 has failed to recognize the object 108 (a textbox in this example), while the backup object detector 204 has correctly identified and labeled the object 108. The image frame 302 has been processed by the main object detector 104, but the detector 104 has failed to flag or label the textbox in the bottom region of the frame. The backup object detector 204 compares the pixel patterns in search regions 208, 210 with stored expected or predicted pixel patterns for this region if the object 108 where to appear in the frame. In this example, the stored pixel patterns for the search regions 208, 210 are a black background color for the pixel colors in those regions. The image frame 302, 306 contain a similar black background pattern in those regions, consequently, the backup object detector 204 labels the image frame 302, 306 as containing the object 108. The search regions 208, 210 are provided as examples only. Fewer or more search regions 208, 210 can also be used. In the case of a textbox, which can be approximated by a rectangle, two slivers of mostly background or border pixels on either side of the rectangle can determine the existence of an entire rectangle in the image frame 306. While the search regions 208 and 210 are shown on the shorter side of the rectangle, the regions 208, 210 can just as well be on the longer side of the rectangle surrounding the text in the object 108.

In some embodiments, the search regions 208, 210 are chosen to be in a margin or background region of the known or predicted location of the object 108, so as to be outside of the object 108 (e.g., not overlapping with text in a textbox, when object 108 is text at a location on the image frame). The range of pixel values in the selected search regions 208, 210 in the known image, is determined and stored. The backup object detector 204 can look for the same range of pixel values and pattern in the regions 208, 210 in subsequent image frames. If a match is found, the subsequent image frame likely includes the selected object and can be labeled accordingly.

### Duplicate Rejection

In some applications, the detected object and/or the image frames containing the detected object can undergo further processing. For example, in the case of text detection, once a textbox is detected, the textbox may be processed using optical character recognition (OCR). Some of the post-processing activities can be computationally demanding. For example, OCR can be slow and consume substantial computing resources, especially in the case of some foreign languages. In these scenarios, a system that can exclude image frames containing duplicate objects can be advantageous. For example, if the object of interest is text and the post processing includes OCR, if image frames containing duplicate text can be excluded, the computational resources will be preserved, and efficiency will increase. In the case of text in video image frames, duplicates can occur with some frequency, as the same textbox may appear in multiple succeeding and streaming video image frames.

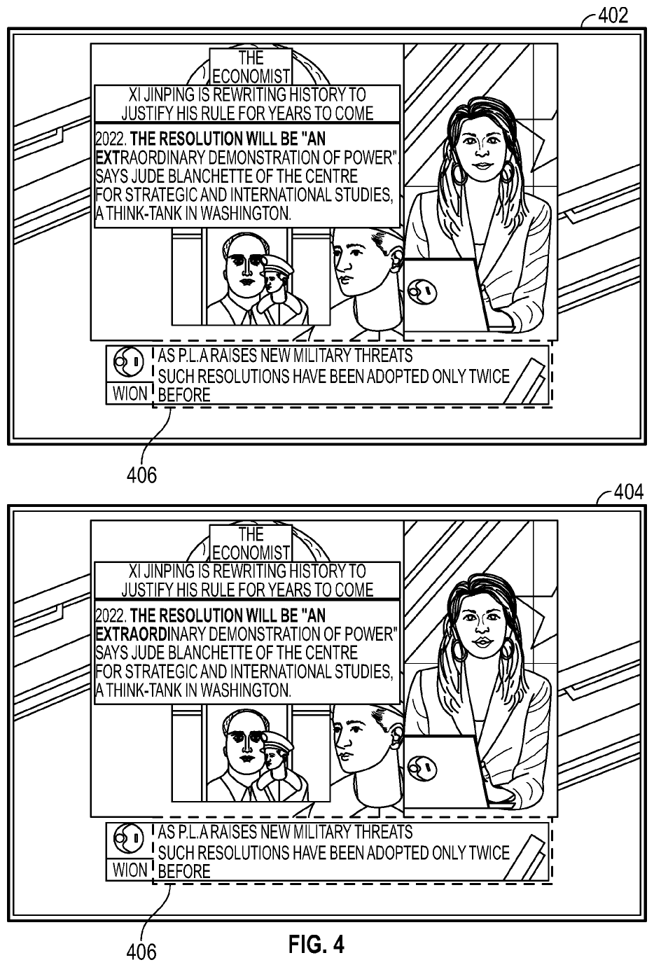

FIG. 4 illustrates a situation where the same textbox 406 appears in two video image frames 402 and 404. The two images may be slightly different in other aspects, but the textbox 406 at the bottom of the image frames are the same between the two. In this scenario, it is beneficial to identify and exclude the image frame 404 from post processing, including for example, the OCR operations. Whether or not the textbox 406 is determined by the main object detector 104 or by the backup object detector 204, a pixel-to-pixel comparison between the respective regions of the textbox 406 can be performed to determine whether the same textbox is repeated between the image frames. A pixel-to-pixel comparison is more efficient than performing OCR operations and comparing text between the detected textboxes in the image frames.

Pixel-to-pixel comparison can include operations, such as comparing pixel values, including color, intensity, coordinates, and other characteristics. The pixel-to-pixel comparison occurs in the regions of an image frame expected to include an object of interest, such as the textbox 406. The pixel-to-pixel comparison is not performed on the entirety of the image frame 404. Consequently, determining a duplicate object can be performed efficiently. The pixel values and patterns from a region of interest, such as the region of the textbox 406 in a previous image frame 402 can be stored in a cache and compared against pixel values in the same region in a subsequent frame 404. If the pixel values are the same, for example, the pixel values are matching to an extent above a predetermined threshold (e.g., more than 90% matching in stored values), the subsequent frame 404 is labeled as duplicate and excluded from post processing operations, such as OCR. If the pixel values do not match (e.g., are less than 90% matching in stored values), the pixel values corresponding to the region of interest in the image frame 404 are stored in the cache as the new pixel values of the region of interest and compared against future regions of interest in subsequent image frames.

### Method of Object Detection and Post Processing

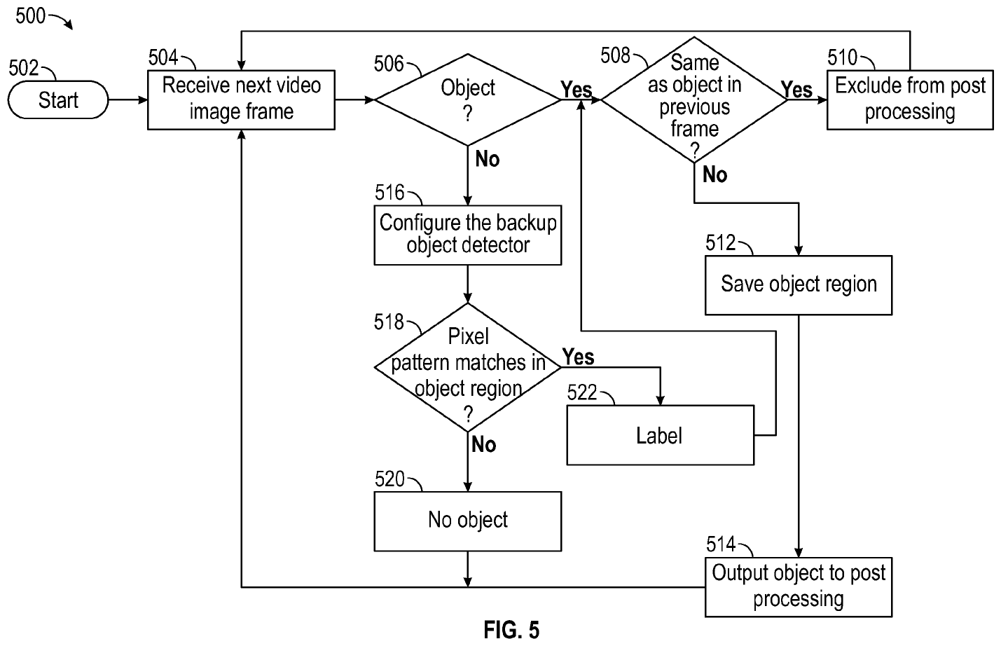

FIG. 5 illustrates a method 500 of object detection and post processing according to an embodiment. The method starts at step 502 and can continuously run to process incoming video image frames from a video feed. At step 504, a next video image frame is received. At step 506, a main object detector, such as an artificial intelligence object detector model is initiated and configured to detect a selected object. For example, the selected object can be a textbox at the bottom of a video image frame obtained from a news broadcast video feed/stream or a video game output. If the main object detector detects an object, the method moves to step 508, where it is determined whether the detected object is the same object that was present in a previous video image frame. If the detected object is the same as the object in a previous image frame, the method moves to step 510, where the image is excluded from further post processing. For example, an OCR step may be bypassed for an image frame determined to have the same object as the object previously processed in a previous frame.

If the detected object is not the same, the method moves to step 512, where the object region, for example, pixel values are saved in a cache to compare against future detected objects. At step 514, the object is outputted to a post processing module, such as an OCR module if the object is text. The method can continue from step 504 by receiving the next video image frame. At step 506, if the main object detector does not detect an object, the method moves to step 516, where a backup object detector is configured (or can be previously configured) to analyze a consistent region of a selected object, which remains substantially unchanged from image frame to image frame, in the object region. The consistent region can include a border, such as a rainbow border, or other patterns in the background or border of the selected object. The backup object detector can be configured with location of the selected object, sample regions of the selected object and pixel values therein. Sample regions can be based on a geometric or non-geometric shape approximating the selected object. Sample regions can be chosen in a manner that existence of the same pixel patterns in the sample regions can indicate the likelihood of existence of the entire selected approximate shape and the selected object in a location. For example, sample regions of two slivers on either side of a rectangle can indicate a rectangle. The sample regions pixel values, locations and other characteristics are stored in a cache.

Next at step 518, the backup object detector compares the pixel patterns and other characteristics of the sample regions in the video image frame with the stored characteristics in the cache. If the pixel patterns in the cache and the sample regions of the current video image frames do not match, the backup object detector determines that the object is not present in the video image frame. The method moves to step 520, indicating “no object found,” and next to step 504, where the next video image frame is received and processed.

If the characteristics do match, the backup object detector determines that video image frame contains the selected object. At step 522, the video image frame is labeled accordingly, so the labeled video image frame can subsequently be used in training and improving of the main object detector, used in step 506. The method then moves to step 508, where it is determined whether the object detected by the backup object detector is the same as a previously detected object. Subsequent steps 510, 512, and 514 may also be performed as the case maybe and as described above. The matching in step 518 can be setup with appropriate thresholds depending on the underlying pixel values compared.

### Example Implementation Mechanism Hardware Overview

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

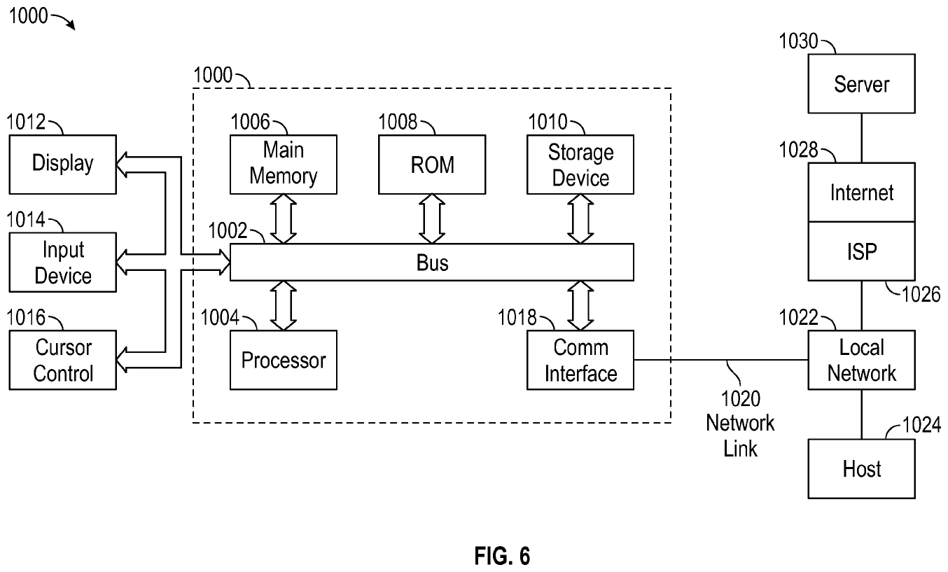

For example, FIG. 6 is a block diagram that illustrates a computer system 1000 upon which an embodiment can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted or received in video conferencing architectures.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions.

Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

### EXAMPLES

It will be appreciated that the present disclosure may include any one and up to all of the following examples.

Example 1: A method comprising: receiving a video feed; initializing a main object detector configured to receive image frames from the video feed and determine whether an object of interest is present in the image frames; executing a backup object detector configured to perform operations comprising: receiving a location of the object of interest in a first image of the video feed; determining a background pattern of the object of interest in the first image; receiving a second image of the video feed; determining whether select regions of the second image in the received location comprise the background pattern; and labeling the second image as comprising the object of interest when the select regions in the received location comprise the background pattern.

Example 2: The method of Example 1, wherein receiving the location comprises receiving coordinates of a geometric shape approximating the boundary of the object with margins outside of the object and wherein the select regions comprise portions of the geometric shape in the margins outside of the object.

Example 3: The method of some or all of Examples 1 and 2, wherein the background pattern comprises pixel values.

Example 4: The method of some or all of Examples 1-3, wherein the object comprises text and the method further comprises: storing the select regions of the second image frame when the select regions comprise the background pattern in the received location; performing optical character recognition on the second image frame in the received location; receiving a third image frame; determining whether the third image frame in the select regions comprises the background pattern in the received location; performing a pixel comparison between the received location in the second and third image frames; and when a similarity threshold between the pixels in the received location in the second and third image frames are above a predetermined threshold, bypassing performing optical character recognition on the third image frame.

Example 5: The method of some or all of Examples 1-4, wherein the main object detector is a trainable model using training data, and wherein the training data comprises a plurality of labeled second images.

Example 6: The method of some or all of Examples 1-5, wherein determining the background pattern of the object in the first image comprises: receiving a geometric shape approximating boundary of the object in the first image with margins outside of the object; determining a range of pixel values in the select regions in the geometric shape in first image in the received location, wherein the select regions are selected to be in the margins outside of the object; determining the background pattern, at least in part, based on the range of pixel values.

Example 7: The method of some or all of Examples 1-6, wherein the select regions are chosen to be in regions having minimum variation in pixel color values.

Example 8: The method of some or all of Examples 1-7, wherein the object comprises text and the select regions comprise a border surrounding the text.

Example 9: The method of some or all of Examples 1-8, wherein the object comprises text and the method further comprises: when the object detector detects the object in an image frame, determine whether the object is the same object as a previous image frame; when the object is the same object, bypass performing OCR on the object; when the object is not the same object, store the object as the previous frame object to compare against future detected objects; when the object detector does not detect the object in the image frame, perform object detection using the backup object detector; when the backup object detector detects the object, label the image frame as containing the object and determine whether the object is the same as object in a previous image frame; when the object detected by the backup object detector is similar to an object in a previous frame within a same threshold, bypass performing OCR on the object detected by the backup detector; and when the object detected by the backup object detector is not similar to the object in the previous frame, store the object detected by the backup object detector as the previous image frame object to compare against future detected objects.

Example 10: A non-transitory computer storage that stores executable program instructions that, when executed by one or more computing devices, configure the one or more computing devices to perform operations comprising: receiving a video feed; initializing a main object detector configured to receive image frames from the video feed and determine whether an object of interest is present in the image frames; executing a backup object detector configured to perform operations comprising: receiving a location of the object of interest in a first image of the video feed; determining a background pattern of the object of interest in the first image; receiving a second image of the video feed; determining whether select regions of the second image in the received location comprise the background pattern; and labeling the second image as comprising the object of interest when the select regions in the received location comprise the background pattern.

Example 11: The non-transitory computer storage of Example 10, wherein receiving the location comprises receiving coordinates of a geometric shape approximating the boundary of the object with margins outside of the object and wherein the select regions comprise portions of the geometric shape in the margins outside of the object.

Example 12: The non-transitory computer storage of some or all of Examples 10 and 11, wherein the background pattern comprises pixel values.

Example 13: The non-transitory computer storage of some or all of Examples 10-12, wherein the object comprises text and the operations further comprise: storing the select regions of the second image frame when the select regions comprise the background pattern in the received location; performing optical character recognition on the second image frame in the received location; receiving a third image frame; determining whether the third image frame in the select regions comprises the background pattern in the received location; performing a pixel comparison between the received location in the second and third image frames; and when a similarity threshold between the pixels in the received location in the second and third image frames are above a predetermined threshold, bypassing performing optical character recognition on the third image frame.

Example 14: The non-transitory computer storage of some or all of Examples 10-13, wherein the main object detector is a trainable model using training data, and wherein the training data comprises a plurality of labeled second images.

Example 15: The non-transitory computer storage of some or all of Examples 10-14, wherein determining the background pattern of the object in the first image comprises: receiving a geometric shape approximating boundary of the object in the first image with margins outside of the object; determining a range of pixel values in the select regions in the geometric shape in first image in the received location, wherein the select regions are selected to be in the margins outside of the object; determining the background pattern, at least in part, based on the range of pixel values.

Example 16: The non-transitory computer storage of some or all of Examples 10-15, wherein the select regions are chosen to be in regions having minimum variation in pixel color values.

Example 17: The non-transitory computer storage of some or all of Examples 10-16, wherein the object comprises text and the select regions comprise a border surrounding the text.

Example 18: The non-transitory computer storage of some or all of Examples 10-17, wherein the object comprises text and the operations further comprise: when the object detector detects the object in an image frame, determine whether the object is the same object as a previous image frame; when the object is the same object, bypass performing OCR on the object; when the object is not the same object, store the object as the previous frame object to compare against future detected objects; when the object detector does not detect the object in the image frame, perform object detection using the backup object detector; when the backup object detector detects the object, label the image frame as containing the object and determine whether the object is the same as object in a previous image frame; when the object detected by the backup object detector is similar to an object in a previous frame within a same threshold, bypass performing OCR on the object detected by the backup detector; and when the object detected by the backup object detector is not similar to the object in the previous frame, store the object detected by the backup object detector as the previous image frame object to compare against future detected objects.

Example 19: A system comprising a processor, the processor configured to perform operations comprising: receiving a video feed; initializing a main object detector configured to receive image frames from the video feed and determine whether an object of interest is present in the image frames; executing a backup object detector configured to perform operations comprising: receiving a location of the object of interest in a first image of the video feed; determining a background pattern of the object of interest in the first image; receiving a second image of the video feed; determining whether select regions of the second image in the received location comprise the background pattern; and labeling the second image as comprising the object of interest when the select regions in the received location comprise the background pattern.

Example 20: The system of Example 19, wherein determining the background pattern of the object in the first image comprises: receiving a geometric shape approximating boundary of the object in the first image with margins outside of the object; determining a range of pixel values in the select regions in the geometric shape in first image in the received location, wherein the select regions are selected to be in the margins outside of the object; determining the background pattern, at least in part, based on the range of pixel values.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed is:

1. A method comprising:
receiving a video feed;
initializing a main object detector configured to receive image frames from the video feed and determine whether an object of interest is present in the image frames;
executing a backup object detector configured to perform operations comprising:
receiving a location of the object of interest in a first image of the video feed;
determining a background pattern of the object of interest in the first image;
receiving a second image of the video feed;
determining whether select regions of the second image in the received location comprise the background pattern; and
labeling the second image as comprising the object of interest when the select regions in the received location comprise the background pattern.

2. The method of claim 1, wherein receiving the location comprises receiving coordinates of a geometric shape approximating the boundary of the object with margins outside of the object and wherein the select regions comprise portions of the geometric shape in the margins outside of the object.

3. The method of claim 1, wherein the background pattern comprises pixel values.

4. The method of claim 1, wherein the object comprises text and the method further comprises:
storing the select regions of the second image frame when the select regions comprise the background pattern in the received location;
performing optical character recognition on the second image frame in the received location;
receiving a third image frame;
determining whether the third image frame in the select regions comprises the background pattern in the received location;
performing a pixel comparison between the received location in the second and third image frames; and
when a similarity threshold between the pixels in the received location in the second and third image frames are above a predetermined threshold, bypassing performing optical character recognition on the third image frame.

5. The method of claim 1, wherein the main object detector is a trainable model using training data, and wherein the training data comprises a plurality of labeled second images.

6. The method of claim 1, wherein determining the background pattern of the object in the first image comprises:
receiving a geometric shape approximating boundary of the object in the first image with margins outside of the object;
determining a range of pixel values in the select regions in the geometric shape in first image in the received location, wherein the select regions are selected to be in the margins outside of the object;
determining the background pattern, at least in part, based on the range of pixel values.

7. The method of claim 1, wherein the select regions are chosen to be in regions having minimum variation in pixel color values.

8. The method of claim 1, wherein the object comprises text and the select regions comprise a border surrounding the text.

9. The method of claim 1, wherein the object comprises text and the method further comprises:
when the object detector detects the object in an image frame, determine whether the object is the same object as a previous image frame;
when the object is the same object, bypass performing OCR on the object;
when the object is not the same object, store the object as the previous frame object to compare against future detected objects;
when the object detector does not detect the object in the image frame, perform object detection using the backup object detector;
when the backup object detector detects the object, label the image frame as containing the object and determine whether the object is the same as object in a previous image frame;
when the object detected by the backup object detector is similar to an object in a previous frame within a same threshold, bypass performing OCR on the object detected by the backup detector; and
when the object detected by the backup object detector is not similar to the object in the previous frame, store the object detected by the backup object detector as the previous image frame object to compare against future detected objects.

10. Non-transitory computer storage that stores executable program instructions that, when executed by one or more computing devices, configure the one or more computing devices to perform operations comprising:
receiving a video feed;
initializing a main object detector configured to receive image frames from the video feed and determine whether an object of interest is present in the image frames;
executing a backup object detector configured to perform operations comprising:
receiving a location of the object of interest in a first image of the video feed;
determining a background pattern of the object of interest in the first image;
receiving a second image of the video feed;
determining whether select regions of the second image in the received location comprise the background pattern; and
labeling the second image as comprising the object of interest when the select regions in the received location comprise the background pattern.

11. The non-transitory computer storage of claim 10, wherein receiving the location comprises receiving coordinates of a geometric shape approximating the boundary of the object with margins outside of the object and wherein the select regions comprise portions of the geometric shape in the margins outside of the object.

12. The non-transitory computer storage of claim 10, wherein the background pattern comprises pixel values.

13. The non-transitory computer storage of claim 10, wherein the object comprises text and the operations further comprise:
storing the select regions of the second image frame when the select regions comprise the background pattern in the received location;
performing optical character recognition on the second image frame in the received location;
receiving a third image frame;
determining whether the third image frame in the select regions comprises the background pattern in the received location;
performing a pixel comparison between the received location in the second and third image frames; and
when a similarity threshold between the pixels in the received location in the second and third image frames are above a predetermined threshold, bypassing performing optical character recognition on the third image frame.

14. The non-transitory computer storage of claim 10, wherein the main object detector is a trainable model using training data, and wherein the training data comprises a plurality of labeled second images.

15. The non-transitory computer storage of claim 10, wherein determining the background pattern of the object in the first image comprises:
receiving a geometric shape approximating boundary of the object in the first image with margins outside of the object;
determining a range of pixel values in the select regions in the geometric shape in first image in the received location, wherein the select regions are selected to be in the margins outside of the object;
determining the background pattern, at least in part, based on the range of pixel values.

16. The non-transitory computer storage of claim 10, wherein the select regions are chosen to be in regions having minimum variation in pixel color values.

17. The non-transitory computer storage of claim 10, wherein the object comprises text and the select regions comprise a border surrounding the text.

18. The non-transitory computer storage of claim 10, wherein the object comprises text and the operations further comprise:
when the object detector detects the object in an image frame, determine whether the object is the same object as a previous image frame;
when the object is the same object, bypass performing OCR on the object;
when the object is not the same object, store the object as the previous frame object to compare against future detected objects;
when the object detector does not detect the object in the image frame, perform object detection using the backup object detector;
when the backup object detector detects the object, label the image frame as containing the object and determine whether the object is the same as object in a previous image frame;
when the object detected by the backup object detector is similar to an object in a previous frame within a same threshold, bypass performing OCR on the object detected by the backup detector; and
when the object detected by the backup object detector is not similar to the object in the previous frame, store the object detected by the backup object detector as the previous image frame object to compare against future detected objects.

19. A system comprising a processor, the processor configured to perform operations comprising:
receiving a video feed;
initializing a main object detector configured to receive image frames from the video feed and determine whether an object of interest is present in the image frames;
executing a backup object detector configured to perform operations comprising:
receiving a location of the object of interest in a first image of the video feed;
determining a background pattern of the object of interest in the first image;
receiving a second image of the video feed;
determining whether select regions of the second image in the received location comprise the background pattern; and
labeling the second image as comprising the object of interest when the select regions in the received location comprise the background pattern.

20. The system of claim 19, wherein determining the background pattern of the object in the first image comprises:
receiving a geometric shape approximating boundary of the object in the first image with margins outside of the object;
determining a range of pixel values in the select regions in the geometric shape in first image in the received location, wherein the select regions are selected to be in the margins outside of the object;
determining the background pattern, at least in part, based on the range of pixel values.
